(19) United States
(12) Patent Application Publication
(10) Pub. No.: US 2011/0185040 A1
(43) Pub. Date: Jul. 28, 2011

(54) System and Method for Independent Aspect Ratio Touch Screen Optimization

(76) Inventor: James H. Schmidt, Incline Village, NV (US)

(21) Appl. No.: 13/016,869

(22) Filed: Jan. 28, 2011

Related U.S. Application Data
(60) Provisional application No. 61/299,209, filed on Jan. 28, 2010.
(60) Provisional application No. 61/309,754, filed on Mar. 2, 2010.
(60) Provisional application No. 61/309,961, filed on Mar. 3, 2010.

(51) Int. Cl. G06F 15/16

(52) U.S. Cl. 709/217

(57) ABSTRACT

A communication system includes a wireless device and a computer server that is in communication with the wireless device. The computer server is adapted to receive at least one parameter associated with the wireless device and to select at least one template that is optimized to be run on the wireless device. The template is transmitted to the wireless device. A method of selecting a template when a user control location change has occurred is also disclosed.

### CROSS REFERENCE TO RELATED APPLICATIONS

This application claims priority to U.S. provisional patent application Ser. No. 61/299,209, filed Jan. 28, 2010, Ser. No. 61/309,754 filed Mar. 2, 2010 and Ser. No. 61/309,961 filed Mar. 3, 2010. The entire contents of which are herein incorporated by reference.

### FIELD OF THE INVENTION

The present invention relates to wireless communication systems, mobile devices, device display optimization and switching display optimization. More specifically, the present invention relates to systems and methods for independent aspect ratio optimization of client applications and touch screen thin client menu support.

### BACKGROUND

As mobile device displays have become more complex, the complexity of the application programs designed for these devices has also grown. The application designer must plan in advance for differing screen resolutions, portrait and landscape mode and attempt to present a scaled or modified version of the controls and/or media presented to the user. In addition, touch screen devices may utilize a combination of hard keys on the device, soft keys which are part of the device but their use is designated by legends on the display, and programmable buttons displayed only on the touch screen device itself. As the display or the display orientation changes, the controls must change as well.

Wording in U.S. Pat. Nos. 7,614,008 and 7,469,381 describes touch screen displays for general computing and in using gestures to specify actions which would normally be implemented as buttons. Gestures are unique in that they are orientation agnostic, however they are limited in the number of operations they perform and soft or menu buttons still require manipulation with screen orientation changes. Hard buttons may not be accessible at all depending on the screen in use. Beda et al. in U.S. Pat. No. 7,619,633 extends this generic principle to a caching data structure to speed up the control of how information is populated and used within the device. This description provides callback mechanisms whereby the server may request information from the application device to better serve its needs.

Raynor, U.S. Pat. No. 7,542,087 describes a typical implementation wherein an orientation sensor is used to indicate whether a handheld device is in portrait or landscape mode. In this particular implementation, if the user takes a snapshot with the device, the orientation is stored as meta data along with the image so that it can be replayed in the proper orientation. In another implementation, Yiu U.S. Pat. No. 7,418,275 the screen itself can be rotated. In most implementations, however, this is accomplished through simple zoom and pan of the image or web page, see Kaasila et al, U.S. Pat. Nos. 7,219,309 and 7,287,220, Rohrabaugh et al. U.S. Pat. Nos. 7,584,423 and 7,461,353, filner et al. U.S. Pat. No. 7,441,207. All of these patents focus on the device's ability to scale and zoom an arbitrary web page or image in a browser application, rather than focusing on the optimal method of delivering the proper content to the device in the first place.

In order to deliver the proper content for the device, the device must first disclose to the server at least its manufacturer make and model, or its innate capabilities. Similar transactions are disclosed in Bowman-Amuah U.S. Pat. No. 6,601,234 and Browde U.S. Pat. No. 7,574,415 but these focus on general business applications and application interfaces and do not address the necessities of connections, variations of screen types and orientations, and rapid delivery of content that are essential to mobile devices. In other implementations, such as Kennedy et al. U.S. Pat. No. 7,085,590, the sensor determines which mode the screen is in, and then zooms and resizes the content appropriately. The prior art is deficient in a methodology for delivery of the proper content to the device and in a methodology for automatically altering the position and use of application controls.

### SUMMARY OF ONE EMBODIMENT OF THE INVENTION

### Brief Description Of One Embodiment Of The Present Invention

In one embodiment, the present invention comprises a communication system that includes a computer server in communication with the wireless device. The computer server is adapted to receive at least one parameter associated with the wireless device and to select at least one template that is optimized for the wireless device. The template is transmitted to the wireless device.

In another embodiment, the present invention comprises a computerized method. The method includes receiving at least one parameter associated with a wireless device and selecting at least one template that is optimized for the wireless device. The template is transmitted to the wireless device.

In an additional embodiment, the present invention comprises a machine-readable medium comprising instructions, which when implemented by a processor performs the following operations: At least one parameter is received that is associated with a wireless device. A first template is selected from a database of templates. The first template is compiled and transmitted to the wireless device.

In yet another embodiment, the present invention comprises a communication system. The communication system includes a wireless device having a first processor. A computer server is in communication with the wireless device. The computer server has a second processor. Software is operable on the first or second processor to determine if a user control location change has occurred from a first user control location to a second user control location. A template is selected associated with the second user control location and the template is displayed on the wireless device.

The above description sets forth, rather broadly, a summary of one embodiment of the present invention so that the detailed description that follows may be better understood and contributions of the present invention to the art may be better appreciated. Some of the embodiments of the present invention may not include all of the features or characteristics listed in the above summary. There are, of course, additional features of the invention that will be described below and will form the subject matter of claims. In this respect, before explaining at least one preferred embodiment of the invention in detail, it is to be understood that the invention is not limited in its application to the details of the construction and to the arrangement of the components set forth in the following description or as illustrated in the drawings. The invention is capable of other embodiments and of being practiced and carried out in various ways. Also, it is to be understood that the phraseology and terminology employed herein are for the purpose of description and should not be regarded as limiting.

### ADVANTAGES OF ONE OR MORE EMBODIMENTS OF THE PRESENT INVENTION

The various embodiments of the present invention may, but do not necessarily, achieve one or more of the following advantages:

The ability to dynamically arrange controls and control menus during display changes;

The ability to select at least one template that is optimized to be run on a wireless device.

The ability to transmit a template to a wireless device;

Provide a template database that contains a plurality of templates, the templates associated with at least one content rendering format;

The ability to modify a template in real time to best match the capabilities of a mobile communication device;

The ability to modify a template in real time to best match the capabilities of a mobile communication device when an orientation change is detected;

The ability to select and optimize a template for a mobile device;

The ability to transmit wireless device capabilities and parameters to a server;

Provide a template database that contains template versions that match wireless device parameters and capabilities such as screen size, screen orientation, screen resolution, screen color depth, display capabilities, audio capabilities and memory size; and

These and other advantages may be realized by reference to the remaining portions of the specification, claims, and abstract.

### BRIEF DESCRIPTION OF THE DRAWINGS

FIG. 1 is substantially a diagrammatic view of a wireless communication network in accordance with the present invention.

FIG. 2 is substantially a diagrammatic view of a computer server.

FIG. 3 is substantially a diagrammatic view of a wireless communication device.

FIG. 4 is substantially a front view of a wireless communication device.

FIG. 5 is substantially a front view of a wireless communication device changing from a horizontal to a vertical orientation.

FIG. 6 is substantially a flowchart of a method for determining, selecting and transmitting a display template in accordance with the present invention.

FIG. 7 is substantially a flowchart of a method for determining, selecting and transmitting a display template in accordance with the present invention.

### DESCRIPTION OF CERTAIN EMBODIMENTS OF THE PRESENT INVENTION

In the following detailed description of the embodiments, reference is made to the accompanying drawings, which form a part of this application. The drawings show, by way of illustration, specific embodiments in which the invention may be practiced. It is to be understood that other embodiments may be utilized and structural changes may be made without departing from the scope of the present invention.

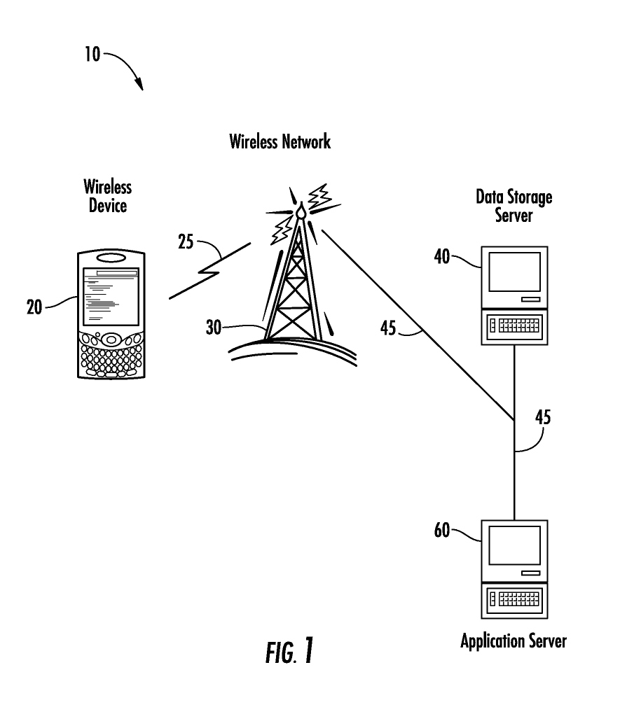

Referring to FIG. 1, a communication system 10 is shown. Communication system 10 can include a mobile or wireless communication device 20, a wireless network 30, a data storage server 40, a hardwired network 45 and an application server 60.

Mobile communication device 20 can be a wide variety of wireless communication devices such as personal data assistants, mobile telephones, laptop computers, pagers, email devices and netbooks. Wireless network 30 can be in communication with mobile communication device 20 through a wireless signal 25. Wireless network 30 can send and receive wireless signals 25. Wireless network 30 can use a wide variety of communication protocols and systems and can include, but is not limited to PCS, GSM, TDMA, CDMA, Internet Protocol (IP) network, Wireless Application Protocol (WAP) network, a WiFi network, Bluetooth or a local area network (LAN).

Wireless network 30 can be in communication with a hardwired network 45. Hardwired network 45 can include a wide variety of hardwired communication devices and transmission mediums such as metal or optical cables and other terrestrial based communication systems. Hardwired network 45 can be in communication with a data storage server 40 and an application server 60. Hardwired network 45 may in itself be a computer server or thin client running on a network. In an embodiment, wireless network 30 may be in direct communication with either data storage server 40 or application server 60.

Data storage server 40 can store, send and receive a wide variety of data, software programs, applications and communications that can be routed from data storage server 40 to wireless network 30 through hardwired network 45. Application programs and data can be routed from application server 60 and data storage server 40 to hardwired network 45.

Application server 60 can contain a wide variety of applications, software programs and instructions that can be executed, downloaded or run on wireless device 20. For example, widgets, applets, midlets or messaging programs and data may be transmitted from application server 60 to wireless device 20. Wireless device 20 may also request, send and receive data and programs from application server 60.

A midlet is defined as an application or program that runs on wireless device 20 that uses the Mobile Information Device Profile (MIDP) of the Connected Limited Device Configuration (CLDC) for the Java ME environment. Typical applications include games running on mobile devices and cell phones which have small graphical displays, simple numeric keypad interfaces and limited network access over HTTP.

Through wireless connection 30, the midlet receives descriptions of content to be rendered to the wireless device display for the purposes of user interaction or the delivery of content.

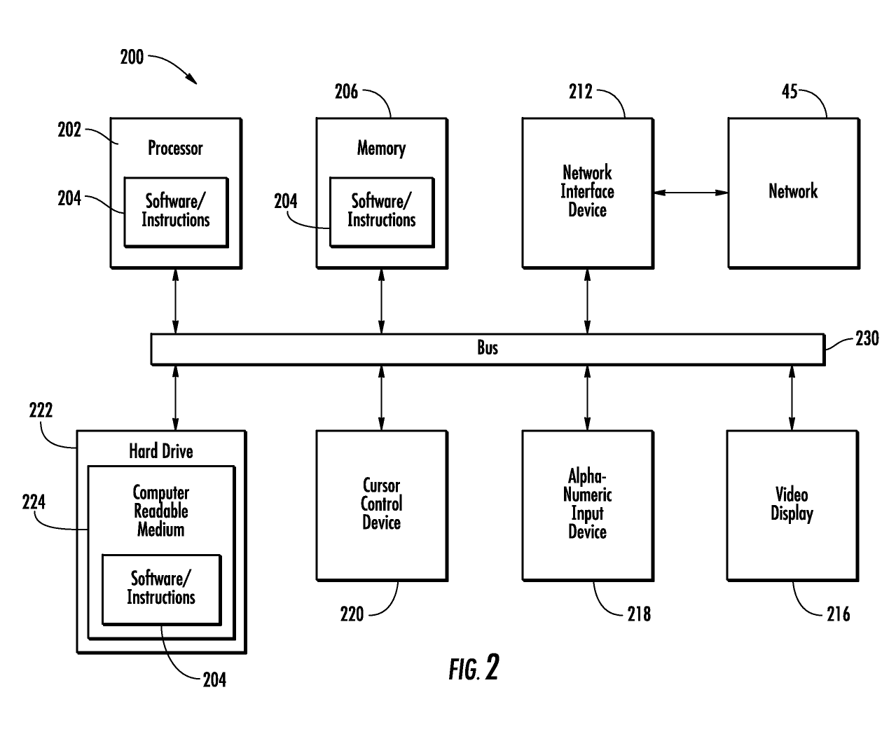

With reference to FIG. 2, a block diagram of a computer server 200 such as data storage server 40 (FIG. 1) or application server 60 (FIG. 1) is shown. Computer server 200 may execute a set of instructions or software programs that cause any one or more of the methods, processes, operations, applications, or methodologies discussed herein to be performed.

In a networked embodiment, computer server 200 may operate in a server-client network environment, or as a peer machine in a peer-to-peer (or distributed) network environment.

Computer server 200 can include a processor or central processing unit 202 and a main memory 206, which communicate with each other via a bus 230. The computer server 200 further includes a video display 216, an alphanumeric input device 218, a cursor control device 220 such as a mouse, a hard drive unit 222 and a network interface device 212.

The drive unit 222 includes a machine-readable medium 224 on which is stored one or more sets of instructions such as software programs 204 that include any one or more of the methodologies or functions described herein. The software 204 may also reside, completely or at least partially, within the main memory 206 and/or within the processor 202 during execution thereof by the computer server 200. The main memory 206 and the processor 202 also comprise machine-readable media. The software 204 may include data objects and applications that can be transmitted or received over network 45 via the network interface device 212.

While the machine-readable medium 224 is shown in an example embodiment to be a single medium, the term, “machine-readable medium”, should be taken to include a single medium or multiple medium such as a centralized or distributed database, and/or associated caches and servers that store one or more sets of instructions. The term, “machine-readable medium”, shall also be taken to include any medium that is capable of storing, encoding or carrying a set of instructions for execution by the machine and that cause the machine to perform any one or more of the methodologies shown in the various embodiments of the present invention. The term, “machine-readable medium”, shall accordingly be taken to include, but not be limited to, solid-state memories, optical and magnetic media, and carrier wave signals.

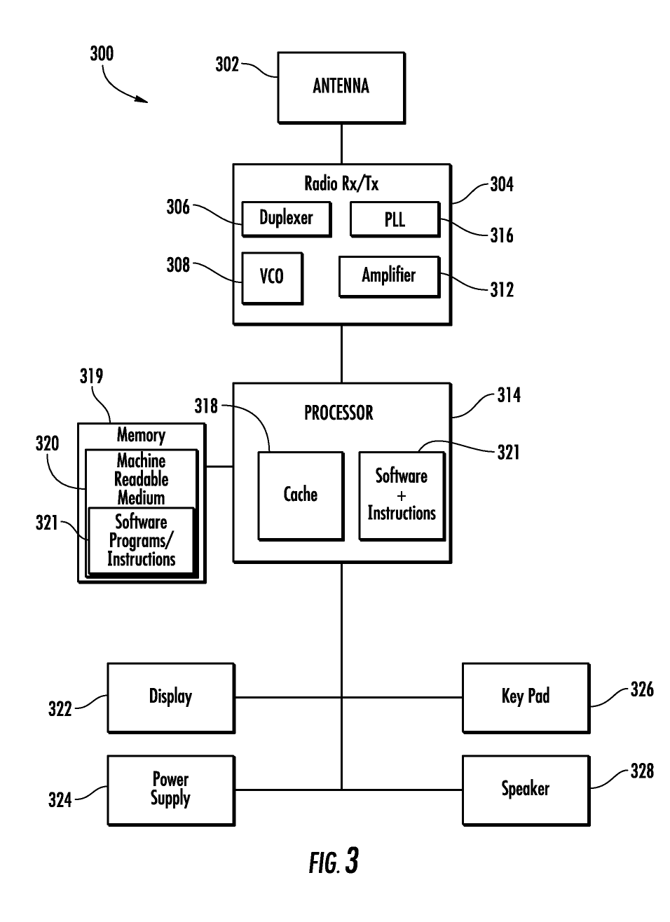

Turning now to FIG. 3, a diagrammatic view of a wireless communication device 300 such as wireless device 20 of FIG. 1 is shown. An example of a mobile device for use with the methods and systems described herein is a self-powered wireless device capable of a wide-area or local wireless communication with a plurality of other of hand-held, mobile, self-powered wireless devices or with communication networks such as base stations that are at a fixed location. The hand-held, mobile, self-powered wireless device can contain a memory, a human input device, a display and a processor. The memory can store a plurality of data relating to applications, data objects and other data.

Communication device 300 can comprise an antenna 302, a radio section 304, a processor 314 and a memory 320. Radio section 304 includes a duplexer 306, voltage controlled oscillator (VCO) 308, phase lock loop circuit (PLL) 310 and an amplifier 312. Duplexer 306 is in communication with antenna 302. Duplexer 306, VCO 308, PLL 310 and an amplifier 312 are in communication with each other. Radio section 304 can transmit and receive RF signals that contain data objects and applications through antenna 302. Any signals received by antenna 302 are processed by radio 304. The processing may include amplification and filtering of the radio frequency signals and analog to digital conversion of any data and information received.

Radio section 304 is in communication with processor 314. Processor 314 can include a memory cache 318 for the storage of frequently used data and software and instructions 321 that may reside in processor 314 for execution on processor 314. Memory 319 is in communication with processor 314. Memory 319 can be a wide variety of memory devices such as flash memory, RAM, ROM or EPROM memory devices.

Memory 319 may include a machine-readable medium 320 on which is stored one or more sets of instructions such as software programs 321 that include any one or more of the methodologies or functions described herein. The software 321 may also reside, completely or at least partially, within the cache 318 and/or within the processor 314 during execution thereof. The software 321 may include data objects and applications that can be transmitted or received with data storage server 40 (FIG. 1) over the wireless network 30 (FIG. 1).

Communication device 300 may further comprise a display 322 such as an LCD display, a keypad 326.

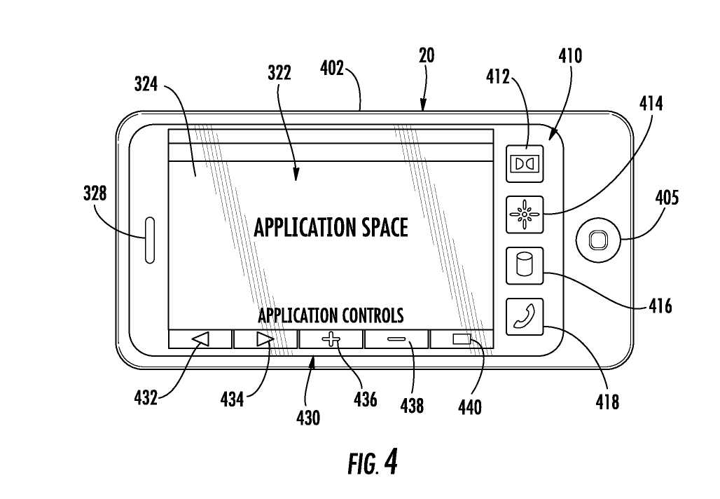

Referring to FIG. 4, a mobile or wireless communication device 20 is shown. Mobile communication device 20 can have a housing 402 that contains a display 322, speaker 328 and camera 405. Display 322 has an application space area 324, user or application control area 430 and fixed control area 410. Display 322 can be a touch sensitive screen.

Application space area 322 can display a wide variety of text, application content and images. The software application may allocate a portion of the screen area to user or application control area 430. User or application control area 430 can have a variety of icons that can be actuated by a user by touch. For example, user or application control area 430 can include scroll icons 432, 434, zoom icons 436, 438 and a selection icon 440. Fixed control area 410 can have a variety of icons that can be actuated by a user by touch. For example, fixed control area 410 can include a music icon 410, an internet icon 414, an e-mail icon 416 and a phone icon 418.

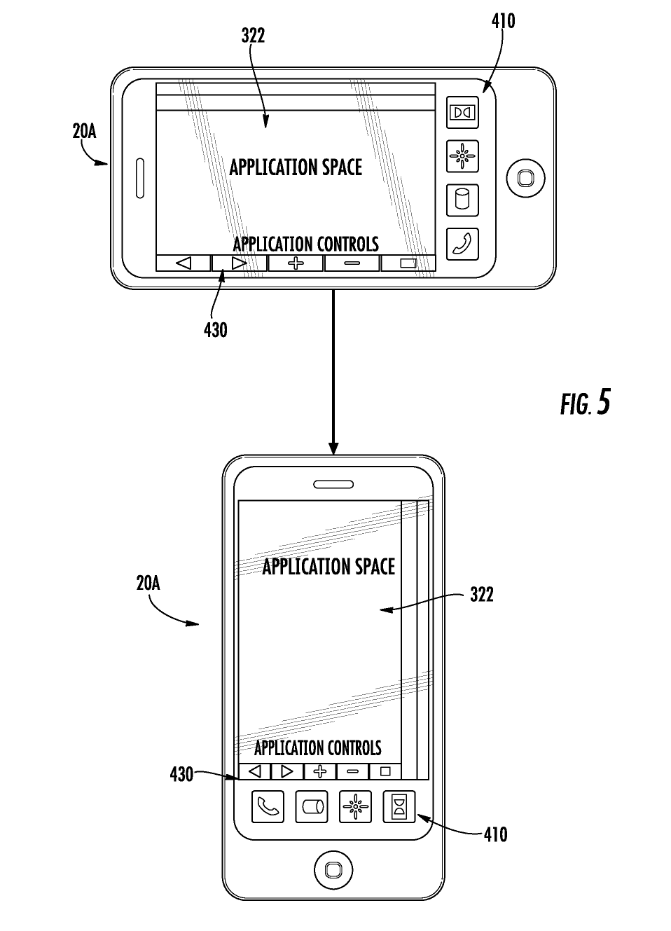

With reference to FIG. 5, a mobile or wireless communication device 20A is shown with a horizontal or landscape orientation. It is noted that mobile communication device 20A has a user or application control area 430 that is located and sized to fill the bottom of the long side of display 322.

The mobile or wireless communication device can be turned or rotated approximately 90 into the vertical or portrait configuration shown by mobile or wireless communication device 20B. A sensor (not shown) within the mobile communication device can detect the orientation change and the processor can select the proper template to display the appropriate content renderings for the new orientation. It is noted that mobile communication device 20B has a user or application control area 430 that is located and sized to fill the bottom of the short side of display 322. The template for the user or application control area 430 can take on any appearance, and they can be placed anywhere appropriate for the application's user interface. These factors can be automatically switched when the display is changed to another size or appearance, or another mode such as portrait/landscape or another color space such as color/grayscale/black and white.

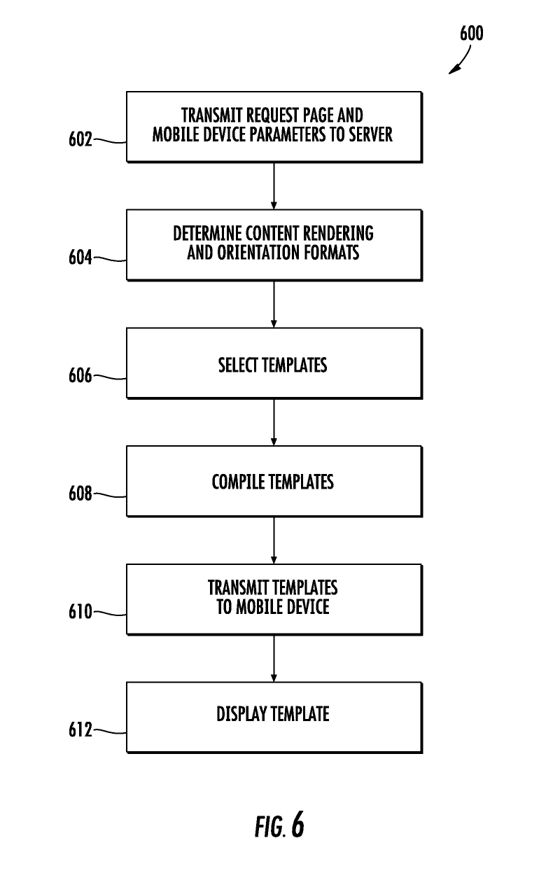

Turning now to FIG. 6, a flowchart of a method 600 for determining, selecting, compiling and transmitting a template is shown. At least a portion of method 600 can be programmed as software 204 stored in memory 206 or drive unit 222 and run on processor 202 of computer server 200 (FIG. 2). Another portion of method 600 can be programmed as software 321 stored in memory 319 and run on processor 314 of wireless communication device 300 (FIG. 3).

At step 602, an application running on the mobile device transmits a page request and mobile device parameters to the server through networks 25 and 45 (FIG. 1). As part of this request, the screen display parameters and a list of all supported screen display parameters are sent and optionally location or other sensory information from the mobile device can be transmitted. This includes the current screen in use and its orientation, the number of screens that the application might utilize, color space, and soft or hard button configurations and user application controls. Next, at step 604, the server utilizes the transmitted location and display information to determine the optimal content rendering and formatting for presentation on the mobile device display. At step 606, one or more templates are selected by the server. Templates are pre-computed or pre-determined renderings of content and format that have been stored for the application. If location data was transmitted to the server, location specific images or content could also be rendered into the display. Templates generated for the application are compiled into a suite of screen images, orientations, and button configurations that are appropriate for the specific mobile device in step 608. The templates are transmitted to the mobile device at step 610. The template with the final image in the format required by the device is then displayed at step 612.

Method 600 is a dynamic real time optimization routine to optimize display templates running on mobile devices by matching the mobile device settings and capabilities with a version of the display template software that optimizes the content rendering and formatting on the wireless device display. Method 600 can evaluate the capabilities of the wireless device and select a version of the template that best matches the operating parameters of the wireless device. Method 600 may perform some or all of the listed steps in an order which may not be in the order listed.

In addition to the graphical or other information for display, the first time the application midlet running on the mobile device contacts the server, the server sends a configuration specification that details the size, position, and function of any controls. These could include soft keys, where the actuation control itself is a physical button but its function is denoted by information on the display, or touch screen controls that are completely defined within the context of a touch screen display. In one embodiment, these buttons could have 9 positions predefined to simplify how the size and locations are specified.

In another embodiment, method 600 could completely define all aspects of the user application controls including but not limited to size, position, color, bitmap, text, font, action upon press, action upon release, bitmap displayed when active, bitmap displayed when inactive, and/or animation. In another embodiment, the active screen area of the display may be modified from the default state defined originally by the mobile device, such that more screen area or a shifted screen area is presented to the user to provide more room for the display controls or the application.

In another embodiment, this adaptive layout mechanism can be used to implement help or other contextual controls that might not be implemented in the default mobile device profile. If native menus are not supported, the server can transmit a template to the thin client. In one embodiment, this template could be HTML based or the template could be customized code or formatting or another standardized methodology such as XML or Javascript. These template controls can be context sensitive, such that each screen of the application may cause only the controls needed to be displayed and reference only those functions required at that time.

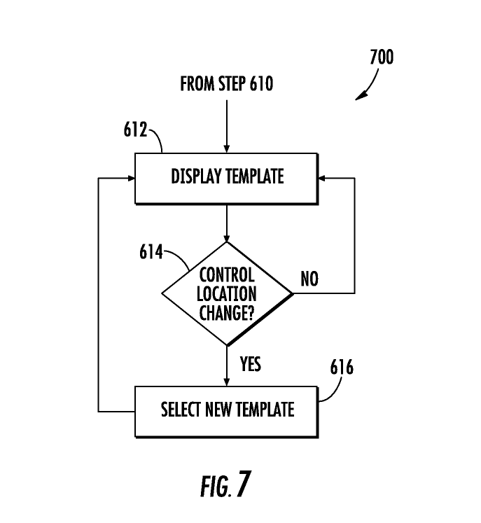

Turning now to FIG. 7, a flowchart of a method 700 for real time dynamic arrangement of user controls on a mobile device is shown. Method 700 can be a continuation of method 600 or the steps of method 700 can be performed alone on a mobile device. At least a portion of method 700 can be programmed as software 204 stored in memory 206 or drive unit 222 and run on processor 202 of computer server 200 (FIG. 2). Another portion of method 700 can be programmed as software 321 stored in memory 319 and run on processor 314 of wireless communication device 300 (FIG. 3).

At step 612 of method 700, the template with the final image in the format required by the device is displayed on the display of the mobile device. At step 614, method 700 checks to see if a user control location change has occurred. The user control location change can be triggered by an orientation change of the mobile device such as from vertical/portrait to horizontal/landscape or may be triggered by instructions from either the mobile device or from the server.

If a user control location change has occurred at step 614, method 700 proceeds to step 616 where a new template that is appropriate for the new user control location and content rendering is selected. Method 700 then returns to step 612 where the new template is shown on the mobile device display. If a user control location change has not occurred at step 614, method 700 returns to step 612 where the current display template continues to be shown on the mobile device display.

In one example, the template for the user controls can take on any appearance, and they can be placed anywhere on the mobile device display that is appropriate for the application's user interface. These factors will automatically be switched when the mobile device display is changed to another size or appearance, or another mode such as portrait/landscape or another color space such as color/grayscale/black and white. This allows applications to be developed much more rapidly and with significantly less complexity, resulting in an easier testing regimen and higher reliability.

In another example, if the native mobile device operating system supports reconfigurable menu functions, the template simply activates calls to the inherent operating system of the device to accomplish the same result. This allows the system to adapt automatically to the appropriate user interface methodology of each mobile phone, freeing the application developer from having to code variations. The user may then select options or activate menu buttons or change the screen or orientation of the display, and all sensor data that might affect the rendered image is provided to the server. The server stores the data in its original format, and may compute different scaling or color space modifications to the originals, or select the next page of data for the application or select appropriate images and renderings for the application display.

In one embodiment, the present invention includes an application management and control system which is screen size and orientation agnostic, the server system must first be apprised of the capability or list of capabilities of the mobile device. It can then provide data to the thin client managing the interface between the application and the device such that menu and other controls can be repositioned to best serve the application independent of the screen size and orientation. To provide eye pleasing, user friendly, and contextually unique displays of graphical or application data and control pages, and the lack of such capability in the prior art, the present invention provides a method for independently optimizing the aspect ratio of a thin client application.

In another embodiment, the present invention includes content rendering via a method whereby a graphical page display comprised of many elements including but not limited to graphics, photo images, text, and clip art is rendered by pre-computation, on-the-fly or in real time to a variety of formats. When the graphical page is requested by the mobile device, the device specifies its display capabilities and the best fit corresponding page is delivered to the device. This information is used by the server to select the proper content or combination of media to deliver in a template to the device to provide the highest quality experience.

In an additional embodiment, a system whereby a graphical page display comprised of many elements including but not limited to graphics, photo images, text, and clip art is rendered by pre-computation or on-the-fly to a variety of formats and orientations. When the graphical page is requested by the mobile device, the device specifies its display capabilities and the best fit corresponding page is delivered to the device. The server may then transmit not only the best content for the device in its current orientation, but content that is suited to all of the supported orientations of the device. This data may be transmitted sequentially and stored in cache, or it may be transmitted only when the orientation of the screen changes.

In another embodiment, different stretching and scaling algorithms can be applied by the server based on the characteristics of the page to be rendered. A page consisting of mostly text, for example, could be rendered differently than one consisting of graphical and image data.

The present invention has several advantages. The present invention can provide a method where mobile device parameters such as screen size, orientation, and other data are transmitted to a computer server. The computer server may determine the content renderings and select a template from a predefined list or database of templates against the capability of the wireless device. The template is compiled and transmitted to the wireless device for display.

Although the description above contains many specifications, these should not be construed as limiting the scope of the invention but as merely providing illustrations of some of the embodiments of this invention. Thus, the scope of the invention should be determined by the appended claims and their legal equivalents rather than by the examples given.

We claim:

1. A communication system comprising:
(A) a wireless device; and
(B) a computer server in communication with the wireless device, the computer server being adapted to:
(a) receive at least one parameter associated with the wireless device;
(b) select at least one template that is optimized for the wireless device; and
(c) transmit the template to the wireless device.

2. The communication system of claim 1, wherein the template is selected from a pre-determined database of a plurality of templates.

3. The communication system of claim 1, further comprising compiling the template.

4. The communication system of claim 1, further comprising determining content rendering and formatting.

5. The communication system of claim 1, further comprising determining if a user control location change has occurred.

6. A computerized method, not all necessarily in the order shown comprising:
(A) receiving at least one parameter associated with a wireless device;
(B) selecting at least one template that is optimized for the wireless device; and
(C) transmitting the template to the wireless device.

7. The method of claim 6, wherein the template is selected from a plurality of templates.

8. The method of claim 6, further comprising compiling the template.

9. The method of claim 6, further comprising determining if a user control location change has occurred.

10. The method of claim 9, further comprising if a user control location change has occurred, selecting a new template.

11. A machine-readable medium comprising instructions, which when implemented by a processor performs the following operations:
(A) receive at least one parameter associated with a wireless device;
(B) select a first template from a database of templates;
(C) compile the first template; and
(D) transmit the first template to the wireless device.

12. The machine readable medium of claim 11, further comprising determining if a user control location change has occurred.

13. The machine readable medium of claim 12, further comprising if the user control location change has occurred, selecting a second template.

14. The machine readable medium of claim 13, further comprising displaying the second template on the wireless device.

15. The machine readable medium of claim 12, wherein the user control location change occurs when an orientation of the wireless device is changed.

16. A communication system comprising:
(A) a wireless device having a first processor;
(B) a computer server in communication with the wireless device, the computer server having a second processor; and
(C) software operable on the first or second processor to:
(a) determine if a user control location change has occurred from a first user control location to a second user control location;
(b) select a template associated with the second user control location; and
(c) display the template on the wireless device.

17. The communication system of claim 16, wherein the user location change occurs when an orientation of the wireless device is changed.

18. The communication system of claim 16, further comprising compiling the selected template.

19. The communication system of claim 16, further comprising transmitting the selected template.

20. The communication system of claim 16, wherein the template is selected from a database of pre-determined templates.
